(19) United States
(12) Patent Application Publication
(10) Pub. No.: US 2009/0167533 A1
(43) Pub. Date: Jul. 2, 2009

(54) FRACTAL CODE AND GENERATING METHOD THEREOF

(75) Inventors: Li-Huei Chen, Hsinchu City (TW); Lih-Guong Jang, Hsinchu City (TW); Ji-Chyun Liu, Taoyuan County (TW); Joseph C. Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/061,651

(22) Filed: Apr. 3, 2008

(30) Foreign Application Priority Data
Dec. 31, 2007 (TW) 96151535

(51) Int. Cl. G08B 13/22

(52) U.S. Cl. 340/572.7; 340/572.1

(57) ABSTRACT

A fractal code is provided. The fractal code includes a substrate and a frequency selective surface (FSS). The FSS includes a fractal configuration designed by an iterative procedure, and the fractal configuration is disposed on the substrate. The fractal configuration is formed by a plurality of fractal circle patterns. The radii of the fractal circle patterns decrease by a specified ratio so as to assume a self-similar property, thereby achieving a multi-spectrum property and generating an identification code in frequency domain (FD-ID code). The FD-ID code is applied with space-feed method, and thus a wireless signal is operated in a predetermined band with reflection or transmission radiations, thereby achieving the function of radio frequency identification.

### CROSS-REFERENCE TO RELATED APPLICATION

This application claims the priority benefit of Taiwan application serial no. 96151535, filed on Dec. 31, 2007. The entirety of the above-mentioned patent application is hereby incorporated by reference herein and made a part of this specification.

### BACKGROUND OF THE INVENTION

1. Field of the Invention

The invention generally relates to a fractal code and a generating method thereof.

2. Description of Related Art

Radio frequency identification (RFID) is a new wireless communication application, which is also referred to as induction electronic chip or induction card. RFID aims to totally replace optical identification system (e.g., Hologram identification tags), and develops in multiple directions, such as production line automation, material management, parking management, automatic toll collection, access control management, automotive theft and collision prevention, medical monitoring, and animal chips.

Refer to FIG. 1, a systematic block diagram of a conventional radio frequency identification system 10 is shown. The radio frequency identification system 10 includes a reader 101 and a tag 102, and the reader 101 is further coupled to a computer 103. The reader 101 first sends a sense carrier to the tag 102, and the tag 102 transmits an electronic identification (ID) code to the reader 101 as an identification key after receiving the sense carrier. In addition, the band of radio frequency is generally 1MHz-000 MHz.

Generally speaking, the communication between the reader 101 and the tag 102 is achieved by wireless communication, and the wireless communication system is mainly composed of a transceiver and an antenna. Antennae have a wide range of applications, including transceiver antenna in radar systems, control antenna on missiles, large and small disk antenna for satellite radio and television, linear antenna in communication system, Yagi-Uda antenna for televisions, monopole antenna for radios, horn antenna for speed sensing radars, and reception antenna for wireless remote control, and the antenna are used everywhere.

Fractal antenna have been widely discussed and researched recently, which have principle properties including a continuous spectrum, multiple bands, high directivity, high emission efficiency etc, and is capable of effectively enhancing the performance of conventional antenna. Fractal configurations of fractal antenna are generally classified into linear, triangular, square and circular configurations. Such configurations are applied in antenna and are referred to as Triadic Koch, Sierpinski gasket, Minkowski island, and Lotus-pods fractal antenna etc. Circular configuration includes typical Lotus-pods fractal antenna and coplanar waveguide (CPW) Lotus-pods fractal antenna, which have a fractal ratio of ⅓, and a fractal dimensionality value D of approximately 1.63; and fractal antenna developed from four mutually tangent circle patterns based on Descartes circle theorem.

However, although the conventional radio frequency identification systems adopts the fractal antenna, the fractal antenna are merely used as antenna, and the identification method thereof still employs electronic identification code in time domain. Similarly, optical identification systems mainly utilize geometrically arranged bar codes for identification, which are basically also identification codes in time domain.

### SUMMARY OF THE INVENTION

An exemplary example of the present invention provides a fractal code including a substrate and a frequency selective surface (FSS). The FSS includes a fractal configuration, which is disposed on a surface of the substrate. The fractal configuration is formed by a plurality of fractal circle patterns. The radii of the fractal circle patterns decrease by a specified fractal ratio, so as to assume a self-similar property.

An exemplary example of the present invention provides a generating method of a fractal code, and a fractal code generated with this method has the identification function. The method includes disposing a substrate, disposing a frequency selective surface, which includes a fractal configuration disposed on the substrate, designing a plurality of fractal circle patterns with iterative procedure, and forming the fractal configuration with the fractal circle patterns.

In order to make the above characteristics and advantages more obvious and apparent, a detailed description is made by way of exemplary example in the following in conjunction with accompanied drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a systematic block diagram of a conventional radio frequency identification system 10.

FIG. 2 is a schematic diagram of a fractal code 20 according to an embodiment of the present invention.

FIG. 3 is a spectrum property diagram of iterative fractal configurations.

FIGS. 4A-4G are schematic diagrams of various fractal codes 40-46 of the circular FSS according to an embodiment of the present invention.

FIGS. 5A-5G are schematic diagrams of various fractal codes 50-56 of the square FSS according to an embodiment of the present invention.

FIGS. 6A-6F are schematic diagrams of various fractal codes 60-65 of the rectangular FSS according to an embodiment of the present invention.

FIGS. 7A-7F are schematic diagrams of various fractal codes 70-75 of the triangular FSS according to an embodiment of the present invention.

FIGS. 8A-8H are schematic diagrams of various fractal codes 80-87 of the rhombic FSS according to an embodiment of the present invention.

FIGS. 9A-9F are schematic diagrams of various fractal codes 90-95 of the various FSS according to an embodiment of the present invention.

FIG. 10 is a schematic flow chart of a generating method of a fractal code with radio frequency identification according to an embodiment of the present invention.

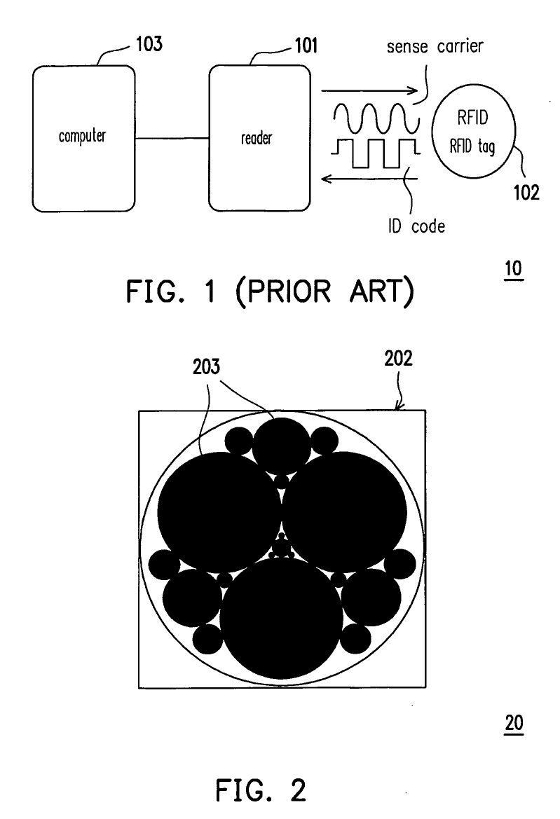

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

An exemplary embodiment of the invention mainly provides a method of designing a fractal reflection and transmission configuration, such as a CPW configuration, which is referred to as a FSS. The FSS has properties such as a continuous spectrum, multiple bands, and a broad bandwidth, and may functions as a tag, also referred to as a fractal tag. In a reader, identification is made based on the spectrum property of the fractal tag. Thus, the fractal configuration of the tag is used to form a fractal code. In the embodiment of the present invention, a circular pattern iterative procedure is used to design the fractal code operated in a predetermined band, thereby achieving the identification function.

In other words, the fractal codes provided in this embodiment identify based on geometric patterns, just as bar codes for optical identification. In brief, a fractal tag is a passive tag with a simple configuration without antenna or power supply, while having the advantage of a low price.

Refer to FIG. 2, a schematic code diagram of a fractal code 20 according to an embodiment of the present invention is shown. The fractal code 20 includes a substrate and a frequency selective surface 202. The fractal configuration 203 is disposed on the substrate. The FSS 202 includes a fractal configuration 203, which is formed by a plurality of fractal circle patterns (a plurality of large and small mutually tangent circle patterns in FIG. 2). The fiactal code 20 in this case is a reflection configuration, since the FSS is hollowed out and the fractal configuration 203 is adhered portion. The radii of the circular fractal patterns decrease by a specified fractal ratio so as to assume a self-similar property, thereby achieving a multi-spectrum property. The fractal code 20 is designed with an iterative procedure, and thus can be operated in a predetermined band, thereby achieving the identification function. The principle lies in that the fractal configuration 203 of the FSS 202 forms a resonance cavity for some specific frequencies and thus has a specific spectrum.

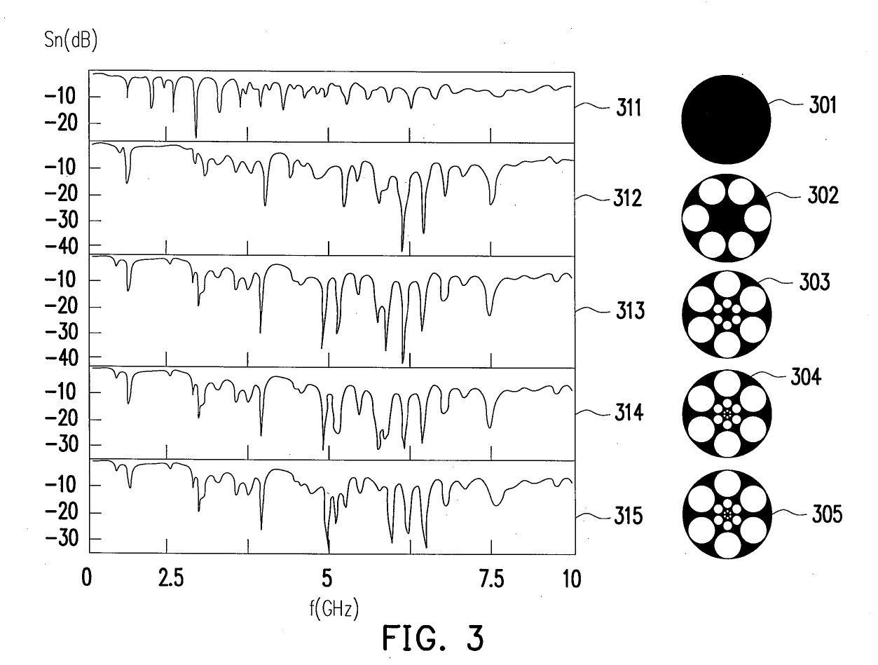

Referring to FIG. 3, a spectrum property diagram of iterative fractal configurations is shown. As described above, the fractal code is designed with the iterative procedure. In an initial status, the original configuration of a FSS 301 is a circle which corresponds to a spectrum 311. After a first iteration, the fractal configuration of the FSS 302 is formed by the original configuration status with six mutually tangent circles being hollowed out. The radius of the six mutually tangent circles is ⅓ of the radius of the large circle in the initial status. At this time, the FSS 302 corresponds to a spectrum 312. As the fractal configurations formed by the FSS 301 and 302 are different, the resultant spectrums 311 and 312 are also different. Then, after a second iteration, the fractal configuration of a FSS 303 is a fractal configuration formed by the fractal configuration from the first iteration with six more mutually tangent circles being hollowed out. The radius of the six more mutually tangent circles is ⅓ of the radius of the six mutually tangent circles from the first iteration. At this time, the FSS 303 corresponds to a spectrum 313.

With the iterative procedure described above, a FSS 304 and its corresponding spectrum 314 resulting from a third iteration and a FSS 305 and its corresponding spectrum 315 resulting from a fourth iteration are obtained. With the designing procedure described above, the different fractal codes having the different resultant spectrums are obtained. Therefore, the fractal configuration of the identification fractal code may be identified by its spectrum property, thereby achieving the identification function. In short, the fractal code described above has a set of identification codes in frequency domain. The identification function may be achieved by using the identification codes in frequency domain.

When fractal code is applied in a radio frequency identification system, the fractal code may be used as the antenna for a reader and an identification tag. As the fractal code has a corresponding spectrum, it can further be used as the identification code of the identification tag. Besides, as the fractal code can be operated in various bands, the above application is also applicable in Microwave (1 GHz-100 GHz) communication systems and functions as the antenna for receiving multi-band and wideband signals. The configuration surface profile of the above fractal code includes such as a plane, a paraboloid, and a curved surface etc. The above frequency selective surface may be easily printed on a dielectric layer by printed circuit technique, and thus has the advantage of a low cost.

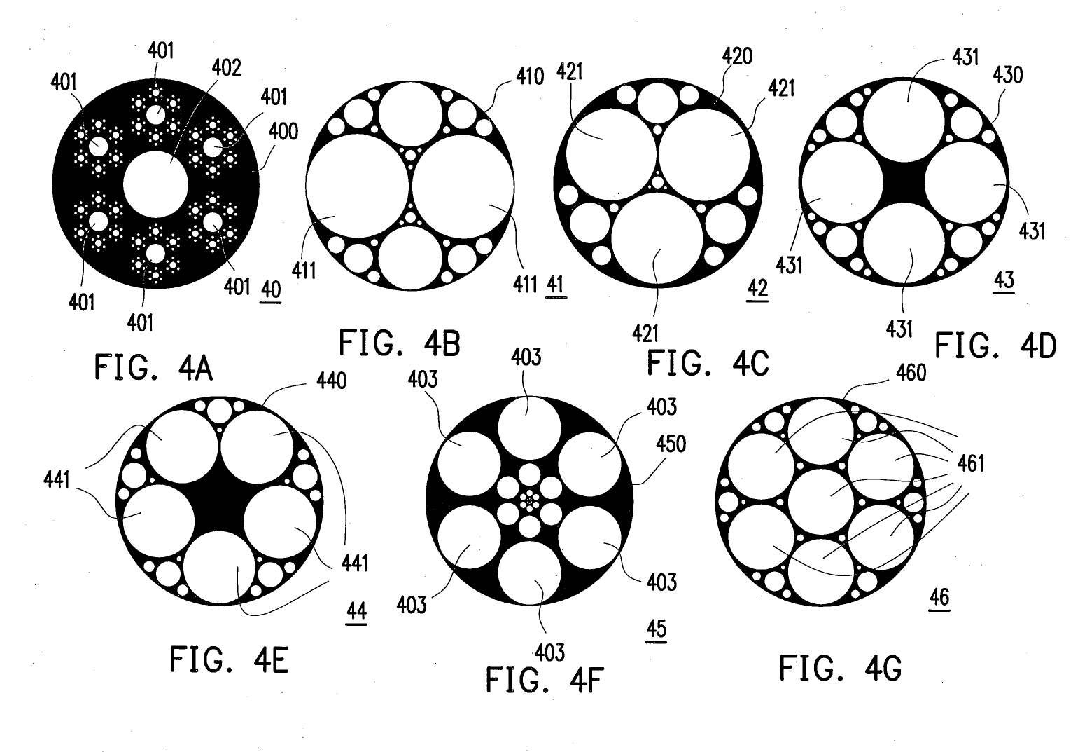

Referring to FIGS. 4A-4G, various fractal codes 40-46 of a circular FSS according to an embodiment of the present invention are shown. The FSS in FIGS. 4A-4G are circular. Each of the FSS includes a fractal configuration formed by different fractal circle patterns. Here, a calculation process for a fractal dimensionality is first defined. The fractal dimensionality is a ratio of a natural logarithm for a number of sub patterns added during each iteration to a natural logarithm for a reciprocal of the fractal ratio. That is to say, D=ln(Ng)/ln(1/ratio), where Ng is the number of the sub patterns added during each iteration, and ratio is the fractal ratio. Besides, in FIGS. 4A-4G, the fractal circle patterns are illustrated in white, where the white indicates the fractal circle patterns being hollowed out, and the black portion indicates the portions that are not hollowed out. In FIGS. 4A-4G, the fractal codes 40-46 is transmission configurations.

As shown in FIGS. 4A and 4F, the fractal ratio in FIGS. 4A and 4F is ⅓, that is, the radii of the fractal circle patterns decrease by a ratio of ⅓. In FIG. 4A, seven circles 401 and 402 are previously disposed in a circular FSS 400 by a ratio of ⅓. Thereafter, near the six peripheral circles 402 of the seven circles 401 and 402, seven more circles are disposed by a ratio of ⅓. Smaller circles are obtained in every iteration, which are called Lotus-pods Type-outward circular fractal patterns. However, in FIG. 4F, six circles 403 are first disposed in a circular substrate 450. Then six more circles are disposed by a ratio of ⅓. Smaller circles are obtained in every iteration, which are called Lotus-pods circular fractal patterns. The fractal dimensionality is D=ln(6)/ln(3), where D is approximately 1.631.

As shown in FIGS. 4B-4E and 4G, the plurality of circular fractal patterns are a plurality of four mutually tangent circle patterns. The so-called four mutually tangent circle patterns are developed from Descartes circle theorem, and Descartes mutually tangent circle theorem has a mathematical expression as follows,

(aᵢ+bᵢ+cᵢ+dᵢ)²=2(aᵢ²+bᵢ²+cᵢ²+dᵢ²) i=1,2, . . .

where aᵢ, b₁, cᵢ, and dᵢ are respectively reciprocals of the radii of the four mutually tangent circles.

If four circles satisfy the above mathematical expression, the four circles are mutually tangent. In short, with three known mutually tangent circles, a fourth circle can be calculated simply using the above mathematical expression. After the calculation, with the second, third, and fourth circles as known circles, the mutually tangent circles thereof can be further calculated. Each calculation is called one iteration. When iterated in the same plane, the assumed circles are mutually tangent and can be space-filled into a fractal configuration. In FIG. 4B, two initial circles 411 are predisposed in a circular FSS 410. In FIG. 4C, three initial circles 421 are predisposed in a circular FSS 420. In FIG. 4D, four initial circles 431 are predisposed in a circular FSS 430. In FIG. 4E, five initial circles 441 are predisposed in a circular FSS 440. In FIG. 4G, seven initial circles 461 are predisposed in a circular FSS 460. After initial circles are predisposed, the fractal codes 41-44 and 46 shown in FIGS. 4B-4E and 4G may be achieved through iterative procedure. The fractal dimensionality of the above four mutually tangent circle patterns is approximately 1.306.

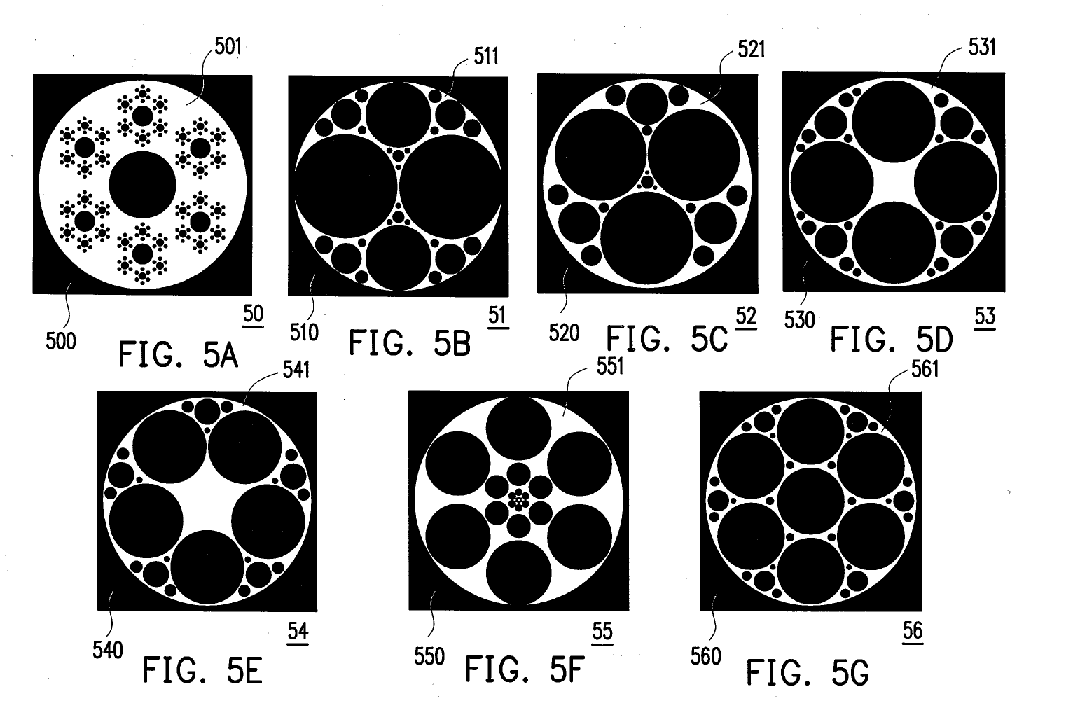

Referring to FIGS. 5A-5G, various fractal codes 50-56 for a square FSS according to an embodiment of the present invention are shown. The FSS in FIGS. 5A-5G are square having a circular fractal configuration formed by different fractal circle patterns.

In FIG. 5A, a circular fractal configuration 501 is disposed in a square FSS 500, and the configuration 501 is a hollowed out transmission surface. The configuration 501 includes a fractal configuration of Lotus-pods Type-outward circular fractal patterns, which is the same as the fractal configuration in FIG. 4A. However, the circular fractal patterns in FIG. 5A are adhered portions instead of hollowed out portions, and thus assume in black. In FIG. 5F, a circular fractal configuration 551 is disposed in a square FSS 550, and the configuration 551 is a hollowed out transmission surface. The configuration 551 includes a fractal configuration of Lotus-pods circular fractal patterns, which is the same as the fractal configuration in FIG. 4F. However, the circular fractal patterns in FIG. 5F are adhered portions instead of hollowed out portions, and thus assume in black. The above fractal codes 50 and 56 has a fractal dimensionality of D=ln(6)/ln(3), where D is approximately 1.631.

As shown in FIGS. 5B-5E and 5G, the plurality of circular fractal patterns are a plurality of four mutually tangent circle patterns. In FIG. 5B, two initial circles are predisposed in a circular fractal configuration 511 of a circle FSS 510. In FIG. 5C, three initial circles are predisposed in a circular fractal configuration 521 of a circle FSS 520. In FIG. 5D, four initial circles are predisposed in a circular fractal configuration 531 of a circle FSS 530. In FIG. 5E, five initial circles are predisposed in a circular fractal configuration 541 of a circle FSS 540. In FIG. 5G, seven initial circles are predisposed in a circular fractal configuration 561 of a circle FSS 560. After the initial circles are predisposed, fractal codes 51-54 and 56 shown in FIGS. 5B-5E and 5G may be obtained through iterative procedure. The fractal dimensionality of the four mutually tangent circle patterns is approximately 1.306.

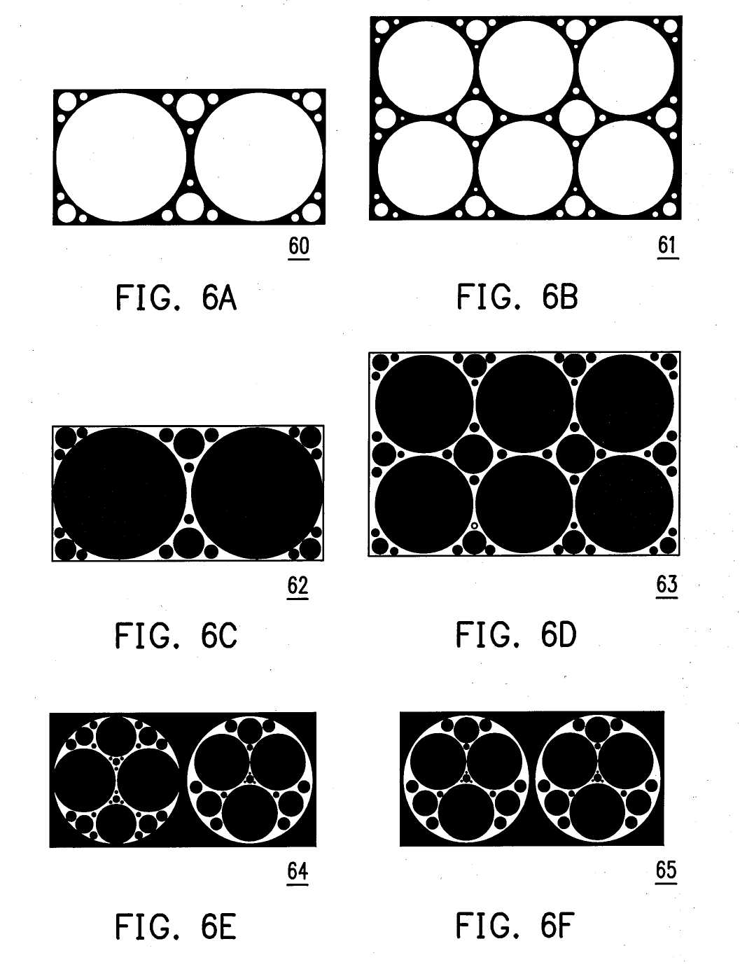

Referring to FIGS. 6A-6F, various fractal codes 60-65 of the rectangular FSS according to an embodiment of the present invention are shown. The FSS in FIGS. 6A-6D are rectangular. Each of the frequency selective surfaces includes a fractal configuration formed by different fractal circle patterns. The FSS in FIGS. 6E-6F are rectangular FSS with two circular fractal configurations. The FSS are transmission surfaces with circles being hollowed out, and each of the FSS includes a fractal configuration formed by different fractal circle patterns. The fractal circle patterns in FIGS. 6A-6F are all four mutually tangent circle patterns.

In both FIGS. 6A and 6C, two initial circles are disposed on the FSS, while in FIGS. 6B and 6D, six initial circles are disposed. The initial circles disposed in the two FSS in FIG. 6E are different in number, of which one FSS has two initial circles disposed while the other has three initial circles disposed. In other words, if a FSS has two or more fractal configuration, the number of the initial circles disposed therein may be different. In FIG. 6F, three initial circles are disposed on the two FSS respectively.

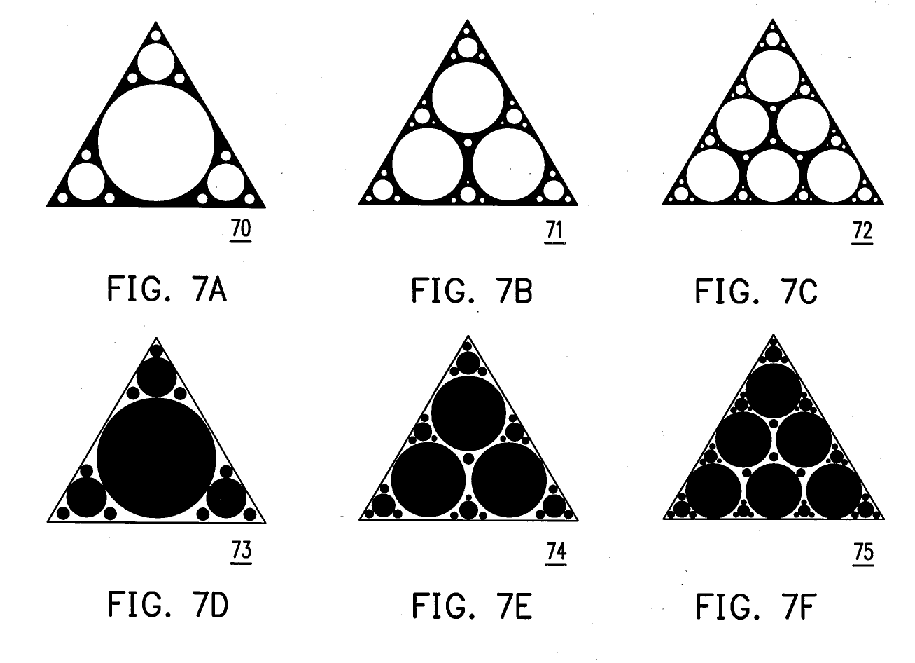

Referring to FIGS. 7A-7F, various fractal codes 70-75 of triangular FSS according to an embodiment of the present invention are shown. The FSS in FIGS. 7A-7F are triangular. Each of the FSS includes a fractal configuration formed by different fractal circle patterns. The circular fractal patterns in FIGS. 7A-7F are all four tangent circle patterns.

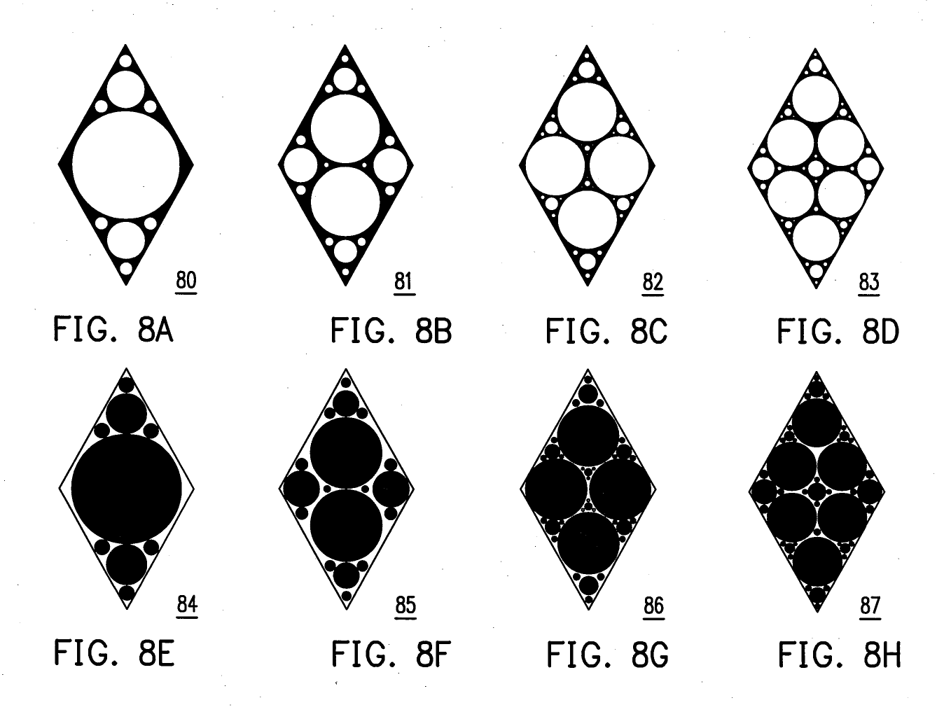

Referring to FIGS. 8A-8H, various fractal codes 80-87 of rhombic FSS according to an embodiment of the present invention are shown. The FSS in FIGS. 8A-8H are rhombic. Each of the FSS includes a fractal configuration formed by different fractal circle patterns. The circular fractal patterns in FIGS. 8A-8H are all four mutually tangent circle patterns.

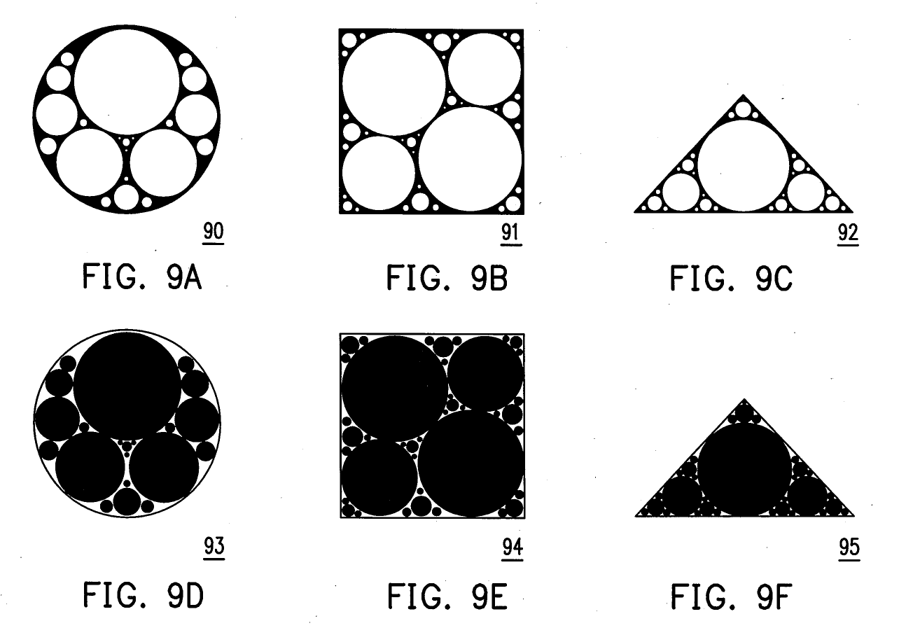

Referring to FIGS. 9A-9F, various fractal codes 90-95 of various FSS according to an embodiment of the present invention are shown. The FSS in FIGS. 9A-9C are respectively circular, square, and triangular, and the circular fractal configuration are the FSS thereof. Each of the FSS includes a fractal configuration formed by different fractal circle patterns. The radius ratios of the initial circles predisposed on the FSS in FIGS. 9A-9C are different, and the circular fractal patterns thereof are call four mutually tangent circle patterns. Besides, FIGS. 9D-9F and FIGS. 9A-9C are similar in principle, except that the FSS are hollowed or non-hollowed transmission surfaces, and the circular fractal patterns are non-hollowed out portions or hollowed out portions.

Other configurations in the FIGS. 4B-4E and 4G, FIGS. 5B-5E and 5G, and FIGS. 6A-8H may employ the design of initial circles with unequal radii as well. As long as the mutually tangent circles satisfy the Descartes mutually tangent circle theorem, more FSS may be designed, so as to obtain various fractal codes as desired.

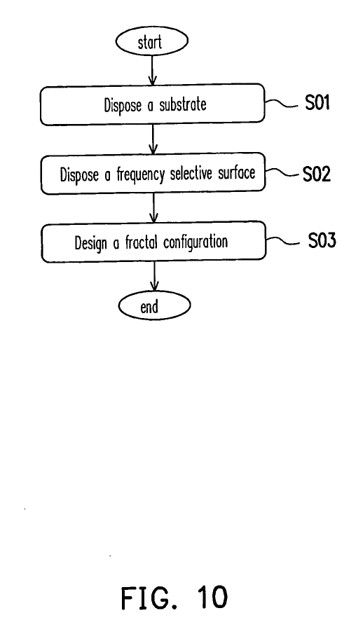

Referring to FIG. 10, a schematic flow chart of a generating method of a fractal code with identification function according to an embodiment of the present invention is shown. The method includes the steps of (S01) disposing a substrate, (S02) disposing a frequency selective surface which includes a fractal configuration disposed on the substrate, and (S03) designing a plurality of fractal circle patterns with iterative procedure and using the fractal circle patterns to form the fractal configuration. The radii of the fractal circle patterns decrease by a specified fractal ratio, so as to assume a self-similar property, thereby achieving a multi-spectrum property.

Fractal codes generated with this method also has the properties and related applications of the aforementioned fractal codes and are thus not detailed herein.

In view of the above, the generating method of a fractal code according to embodiments of the present invention mainly develops fractal codes constructed with a substrate and a FSS. Fractal codes generated with this method have properties such as a wide band, multiple bands, and periodicity in bandwidth, and can be applied in systems such as RFID. The fractal code has responses applicable in radio frequency and microwave band ranges, and accordingly functions as a practical RFID tag. In general applications, the fractal code may be used in a related microwave communication apparatus as the antenna for receiving multi-band and wideband signals. The fractal code has properties such as independence on frequencies, multiple bands and bandwidths, and periodicity, and is thus applicable to antennae for satellite reception and Ultra Wide Band (UWB) systems. Besides, the fractal codes may be easily printed, cheap, and may be used in product marks and tags designing. The genuineness of the product may be identified through the spectrum properties thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fractal code, comprising:
a substrate; and
a frequency selective surface;
wherein the frequency selective surface comprises a fractal configuration, the fractal configuration is disposed on the substrate and is formed by a plurality of fractal circle patterns, the radii of the fractal circle patterns decrease by a specified fractal ratio, so as to assume a self-similar property and form an identification code.

2. The fractal code according to claim 1, wherein the fractal circle patterns are a plurality of Lotus-pods patterns or a plurality of four mutually tangent circle patterns, the fractal code comprises at least forty variations.

3. The fractal code according to claim 2, wherein the fractal ratio of the Lotus-pods patterns is ⅓, and a fractal dimensionality of the Lotus-pods patterns is approximately 1.631.

4. The fractal code according to claim 2, wherein the four mutually tangent circle patterns are obtained from Descartes circle theorem, and a fractal dimensionality value of the four mutually tangent circle patterns is approximately 1.306.

5. The fractal code according to claim 1, wherein the fractal code is applied in a radio frequency identification system, and the fractal code as a radio frequency identification code for a radio frequency identification tag of the radio frequency identification system.

6. The fractal code according to claim 1, wherein a frequency response range of the fractal code is radio frequency band (1-1000 MHz) and microwave band (1-100 GHz).

7. The fractal code according to claim 1, wherein the fractal code is applied in a radio frequency identification system, and the fractal code as an antenna for a reader and a tag in the radio frequency identification system.

8. The fractal code according to claim 1, wherein the fractal code is applied in a microwave communication apparatus, and the fractal code as an antenna for receiving multi-band and wideband signals.

9. The fractal code according to claim 1, wherein a configuration surface profile of the fractal code comprises a plane, a paraboloid, and a curved surface.

10. The fractal code according to claim 1, wherein the identification code is applied in frequency domain with space-feed method, and thus a wireless signal is operated on the frequency selective surface with reflection or transmission radiations.

11. The fractal code according to claim 1, wherein the fractal code is designed with an iterative procedure, and is suitable for being operated in a predetermined band, thereby achieving an identification function.

12. The fractal code according to claim 1, wherein the shape of the FSS comprises a circular, a square, a rectangular, a rhombic, or a triangular.

13. A generating method of a fractal code, comprising:
disposing a substrate;
disposing a frequency selective surface provided with a fractal configuration on the substrate; and
designing a plurality of fractal circle patterns with an iterative procedure, and forming the fractal configuration with the fractal circle patterns;
wherein radii of the fractal circle patterns decrease by a specified fractal ratio so as to assume a self-similar property, thereby achieving a multi-spectrum property and forming an identification code.

14. The generating method of a fractal code according to claim 13, wherein the fractal circle patterns are a plurality of Lotus-pods patterns or a plurality of four mutually tangent circle patterns, the fractal code comprises at least forty variations.

15. The generating method of a fractal code according to claim 14, wherein the fractal ratio of the Lotus-pods patterns is ⅓, and a fractal dimensionality of the Lotus-pods patterns is approximately 1.631.

16. The generating method of a fractal code according to claim 14, wherein the four mutually tangent circle patterns are obtained from Descartes circle theorem, and a fractal dimensionality value of the four mutually tangent circle patterns is approximately 1.306.

17. The generating method of a fractal code according to claim 13, wherein the fractal code is applied in a radio frequency identification system, and functions as a radio frequency identification code for a radio frequency identification tag of the radio frequency identification system.

18. The generating method of a fractal code according to claim 13, wherein a frequency response range of the fractal code is from radio frequency band to microwave frequency band.

19. The generating method of a fractal code according to claim 13, wherein the fractal code is applied in a radio frequency identification system, and functions as an antenna for a reader and a tag in the radio frequency identification system.

20. The generating method of a fractal code according to claim 13, wherein the fractal code is applied in a microwave communication apparatus, and functions as an antenna for receiving multi-band and wideband signals.

21. The generating method of a fractal code according to claim 13, wherein a configuration surface profile of the fractal code comprises a plane, a paraboloid, and a curved surface.

22. The generating method of a fractal code according to claim 13, wherein the shape of the FSS comprises a circular, a square, a rectangular, a rhombic, or a triangular.

23. The generating method of a fractal code according to claim 13, wherein the identification code is applied in frequency domain with space-feed method, and thus a wireless signal is operated on the frequency selective surface with reflection or transmission radiations.
